(19) United States
(12) Patent Application Publication
(10) Pub. No.: US 2009/0087208 A1
(43) Pub. Date: Apr. 2, 2009

(54) IMAGE FORMING METHOD, IMAGE FORMING APPARATUS AND COMPUTER-READABLE MEDIUM

(75) Inventor: Kenji Ogasawara, Kawaguchi-shi (JP)

Correspondence Address: SIDLEY AUSTIN LLP, 717 NORTH HARWOOD, SUITE 3400, DALLAS, TX, 75201, US

(73) Assignee: Konica Minolta Business Technologies, Inc., Tokyo (JP)

(21) Appl. No.: 12/134,505

(22) Filed: Jun. 6, 2008

(30) Foreign Application Priority Data
Sep. 28, 2007 (JP) 2007-255481

(51) Int. Cl. G03G 15/00

(52) U.S. Cl. 399/82

(57) ABSTRACT

Disclosed is an image forming method for forming a combined image by combining a first image and a second image to be combined, the first image including an inserting area in which an inserting image is to be inserted and the second image including the inserting image to be inserted in the inserting area, the method including: placing a first detection mark showing an attribute of the first image in a margin of the first image; and placing a second detection mark in a margin of the second image in a position corresponding to a position of the first detection mark in the first image so that when a combination of the first image and the second image is correct, the second detection mark is integrated to the first detection mark to form a predetermined pattern.

### CROSS-REFERENCE TO RELATED APPLICATIONS

The present U.S. patent application claims priority under the Paris Convention of Japanese Patent Application No. 2007-255481 filed on Sep. 28, 2007 to the Japanese Patent Office, which shall be a basis for correcting mistranslations.

### BACKGROUND

1. Field of the Invention

The present invention relates to an image forming method, an image forming apparatus and a computer-readable medium.

2. Description of Related Art

In recent years, with variable printing becoming common in the area of Print On Demand (POD), ensuring quality of matter printed by variable printing has become an important problem. In variable printing, basically, contents of all pages may be different, thus it is extremely difficult to visually inspect all printed matter as in matter printed by offset printing.

For example, a printed matter inspection apparatus is proposed which scans an image of printed matter printed with data different with respect to each page and provides the necessary masks to extract standard image data (form) of the background picture and variable data, and compares the data to the original data to inspect the printed matter (see Japanese Patent Application Laid-Open Publication No. 2003-54096).

Another inspection method such as printing attached information, such as a barcode representing printed content, in a margin of a printed material and scanning the attached information to compare the scanned data with the data in the database is also used.

However as shown in the techniques above, methods which scan an image or attached information need a relatively large scale system architecture which allows a scanning mechanism to work in conjunction with a data base including accumulated data different with respect to each page. It is difficult for users with a scale of operation which mainly performs visual inspections to install such techniques due to cost. Thus, a method to easily perform visual inspection of all printed matter of whether or not the combination of the combined image in variable printing is correct has been desired.

### SUMMARY

The present invention has been made in consideration of the above problems, and it is one of main objects to easily inspect visually whether or not a combination of a first image and a second image is correct.

To achieve at least one of the above-mentioned objects, an image forming method reflecting one aspect of the present invention forms a combined image by combining a first image and a second image to be combined, the first image including an inserting area in which an inserting image is to be inserted and the second image including the inserting image to be inserted in the inserting area, the method comprising:

placing a first detection mark showing an attribute of the first image in a margin of the first image; and

placing a second detection mark in a margin of the second image in a position corresponding to a position of the first detection mark in the first image so that when a combination of the first image and the second image is correct, the second detection mark is integrated to the first detection mark to form a predetermined pattern.

It is preferable that in the above-described image forming method, the attribute of the first image includes at least one of identification information, a page number and an inserting area attribute of the first image.

It is preferable that in the above-described image forming method, the first detection mark is formed with figures arranged in one direction, the figures having two different densities corresponding respectively to bit values of a binary code which represents the attribute of the first image; and

the second detection mark is formed with the figures arranged in the same direction as the first detection mark and the densities of the figures are opposite of those of the first detection mark.

It is preferable that in the above-described image forming method, the two different densities of the figures which form the first detection mark and the second detection mark are gray and white.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing a functional structure of an image forming apparatus of a first embodiment of the present invention;

FIG. 2A is an example of a content type table;

FIG. 2B is an example of a font type table;

FIG. 2C is an example of a character number type table;

FIG. 2D is an example of an image size type table;

FIG. 3 is an example of a structure of a form registration job;

FIG. 4A is an example of a structure of a print job;

FIG. 4B is an example of a structure of a page-1 information;

FIG. 5 is an example of a structure of data of attribute information of a form image;

FIG. 6A is a diagram showing a portion of a form detection mark when a form identification code is 106;

FIG. 6B is a diagram showing a portion of a content detection mark when a form identification code is 106;

FIG. 7A is an example of a combined result when a form detection mark and a content detection mark with the same form identification code are combined;

FIG. 7B is an example of a combined result when a form detection mark and a content detection mark with a different form identification code are combined;

FIG. 8 is an example of a form image;

FIG. 9 is an example of a content image;

FIG. 10 is an example of an image printed when a correct combination of a form image and a content image are combined;

FIG. 11 is an example of an image printed when an incorrect combination of a form image and a content image are combined;

FIG. 12 is a flowchart showing a form registration job receiving processing performed in an image forming apparatus of the first embodiment;

FIG. 13 is a flowchart showing a processing of generating a form detection mark;

FIG. 14 is a flowchart showing a code rasterization processing;

FIG. 15 is a flowchart showing a print job receiving processing performed in the image forming apparatus of the first embodiment;

FIG. 16 is a flowchart showing a content detection mark generation processing;

FIG. 17 is a flowchart showing a content image printing processing performed in an image forming apparatus of the second embodiment; and

FIG. 18 is an example of when a mark combining a form detection mark and a content detection mark is printed on an edge of a sheet.

### DETAILED DESCRIPTION OF PREFERRED EMBODIMENTS

### First Embodiment

In the following, a first embodiment of an image forming apparatus according to the present invention will be described with reference to the drawings.

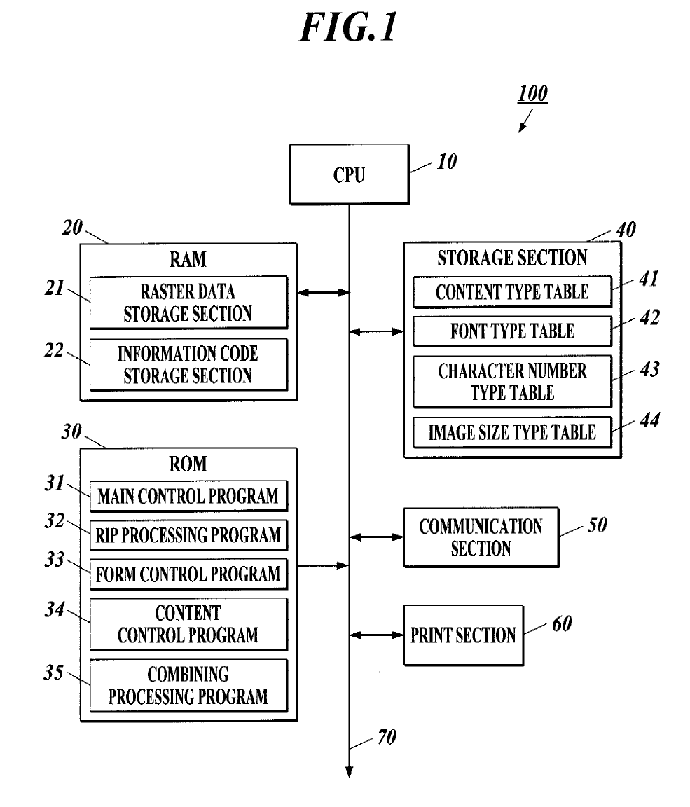

FIG. 1 shows a functional structure of an image forming apparatus 100 of the first embodiment of the present invention.

The image forming apparatus 100 forms a combined image of images to be combined, by combining a first image (hereinafter referred to as a form image) including one or a plurality of inserting areas (hereinafter referred to as a field) in which an inserting image (hereinafter referred to as content) is to be inserted and a second image (hereinafter referred to as a content image) including one or a plurality of contents to be inserted in each field of the form image. The image forming apparatus 100 performs variable printing by combining different content images to the form image.

As shown in FIG. 1, the image forming apparatus 100 comprises, a Central Processing Unit (CPU) 10, a Random Access Memory (RAM) 20, a Read Only Memory (ROM) 30, a storage section 40, a communication section 50, and a print section 60, and the sections are connected to each other with a bus 70.

According to an instruction signal received by the communication section 50, the CPU 10 reads various processing programs stored in the ROM 30, and in conjunction with the programs, the CPU 10 centrally controls processing and operation of the sections of the image forming apparatus 100.

Specifically, the CPU 10 centrally controls the processing and operation performed in the image forming apparatus 100 in conjunction with a main control program 31 stored in the ROM 30.

In conjunction with a Raster Image Processor (RIP) processing program 32 stored in the ROM 30, the CPU 10 performs the RIP processing which develops data of a character string and an image in raster data (bit map). The raster data generated by the RIP processing is stored in the raster data storage section 21 of the RAM 20.

In conjunction with a form control program 33 stored in the ROM 30, the CPU 10 generates a first detection mark (hereinafter referred to as form detection mark) which shows an attribute of a form image. The CPU 10 places the form detection mark in a margin of the form image to combine the form detection mark to the form image.

In conjunction with a content control program 34 stored in the ROM 30, the CPU 10 generates a second detection mark (hereinafter referred to as content detection mark) which is integrated to a form detection mark to form a predetermined pattern when a combination of the content image and the form image is correct. In the first embodiment, the “predetermined pattern” is a pattern in a solid gray with a uniform density. The CPU 10 places the content detection mark in a margin of the content image at a position corresponding to the position of the form detection mark in the form image to combine the content detection mark to the content image.

In conjunction with the combining processing program 35 stored in the ROM 30, the CPU 10 combines the raster data of the images to be combined. For example, the CPU 10 combines the form image on which the form detection mark is combined and the content image on which the content detection mark is combined.

The RAM 20 forms a work area where various processing programs performed by the CPU 10 and data of these programs are temporarily stored. The RAM 20 includes a raster data storage section 21 and an information code storage section 22.

The ROM 30 stores various processing programs, data and the like such as the main control program 31, the RIP processing program 32, the form control program 33, the content control program 34 and the combining processing program 35, which are performed by the CPU 10.

The storage section 40 is a storage apparatus such as a hard disk for storing various data and stores a content type table 41, a font type table 42, a character number type table 43, an image size type table 44, etc.

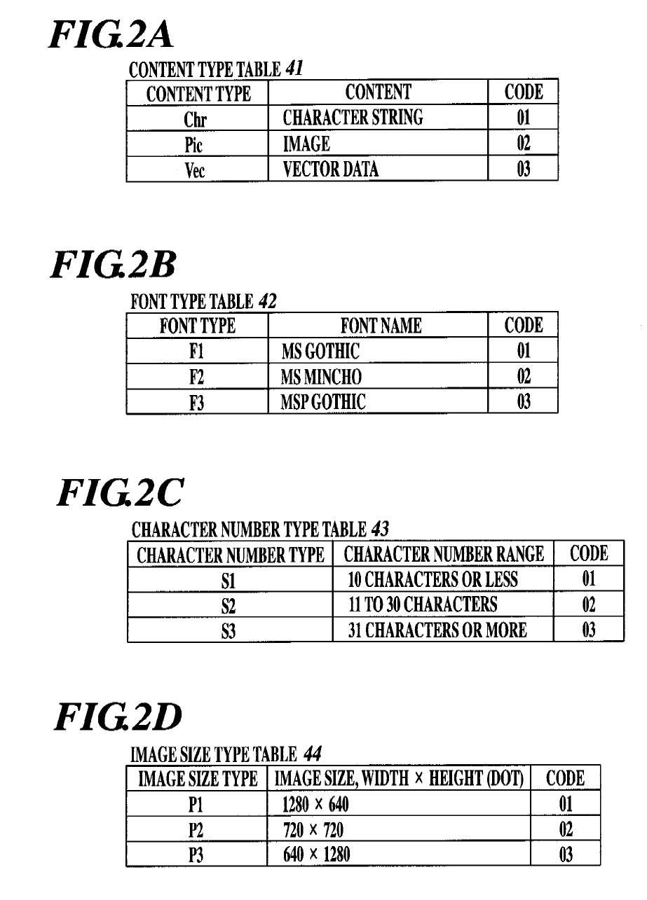

FIG. 2A shows an example of the content type table 41. The content type table 41 is a table in which content type, content, and code are associated to each other. The content type represents a classification of the content. For example, as for the content type “Chr”, the content is “character string” and the code is “01”. As for the content type “Pic”, the content is “image” and the code is “02”. As for the content type “Vec”, the content is “vector data” and the code is “03”.

FIG. 2B shows an example of the font type table 42. The font type table 42 is a table in which font type, font name, and code are associated to each other. The font type represents a classification of the font when the content is a character string. For example, as for the font type “F1”, the font name is “MS Gothic” and the code is “01”. As for the font type “F2”, the font name is “MS Mincho” and the code is “02”. As for the font type “F3”, the font name is “MS P Gothic” and the code is “03”.

FIG. 2C shows an example of a character number type table 43. The character number type table 43 is a table in which character number type, character number range, and code are associated to each other. The character number type represents a classification of the length of the character string when the content is a character string. For example, as for the character number type “S1”, the character number range is “10 characters or less” and the code is “01”. As for the character number type “S2”, the character number range is “11 to 30 characters” and the code is “02”. As for the character number type “S3”, the character number range is “31 characters or more” and the code is “03”.

FIG. 2D shows an example of an image size type table 44. The image size type table 44 is a table in which image size type, image size, and code are associated to each other. The image size type represents a classification of a size (dots) of a height and width of an image when the content is an image. For example, as for the image size type “P1”, the image size is “1280×640” and the code is “01”. As for the image size type “P2”, the image size is “720×720” and the code is “02”. As for the image size type “P3”, the image size is “640×1280” and the code is “03”.

The communication section 50 is a functional section for connecting to a network such as a Local Area Network (LAN) and performing data communication with an external device.

The print section 60 forms an image on a sheet with electrophotography. The print section 60 comprises, a photoconductive drum, a charging section for charging the photoconductive drum, a light exposing section for exposing the photoconductive drum to light according to the image data, a developing section for applying toner to the photoconductive drum, a transferring section for transferring a toner image formed on the photoconductive drum onto a sheet and a fusing section for fusing the toner image formed on the sheet. The print section 60 may use an ink-jet method, thermal transfer method, etc.

The image forming apparatus 100 receives a print instruction of variable printing through the network with the communication section 50 and prints out with the print section 60. Specifically, the image forming apparatus 100 receives through the network a registration job (hereinafter referred to as form registration job) including information concerning the form image which is the common portion of the variable printing. Then, the image forming apparatus 100 receives through the network a print job (hereinafter referred to as print job) including information concerning the content image which is the variable section of the variable printing. The combining of the form image and the content image and printing is performed in the print job processing. The form registration job and the print job may be received together as one job.

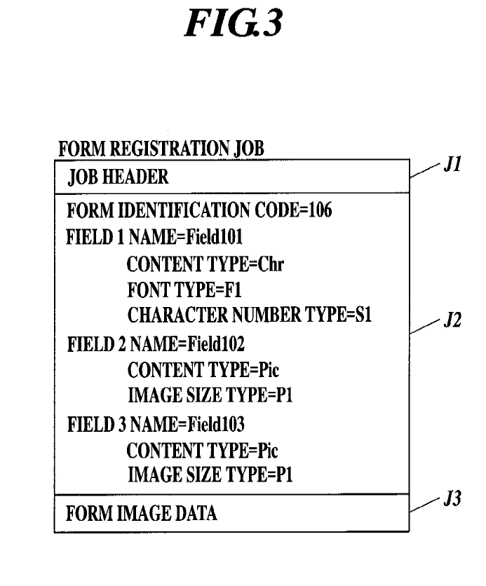

FIG. 3 shows an example of a structure of a form registration job. The form registration job includes a job header J1, form information J2 and form image data J3. The job header J1 includes information such as sheet size of the form image. The form information J2 includes a form identification code (106) which is identification information of the form image and field attribute information. Here, the field attribute information includes identification names of the fields 1 to 3 (Field 101 to 103) and content type (Chr, Pic, etc.). When the content type is character string (Chr), the field attribute information further includes font type (F1, F2, F3) and character number type (S1, S2, S3). When the content type is image (Pic), the field attribute information includes image size type (P1, P2, P3).

In the example of the form registration job shown in FIG. 3, as for field 1, the content is “character string”, the font is “MS Gothic”, the character number is “10 characters or less”. As for field 2 and field 3, the content is “image” and the image size is “1280×640”.

Here, the content type table 41, the font type table 42, the character number type table 43 and the image size type table 44 are prepared beforehand and the content type, font type, character number type and the image size type of the form registration job are described according to the relationship shown in each table, however, instead of classification using tables, the values may be directly specified in the form information of the form registration job. For example, the value of the dots of the length and width of the image size may be directly specified in the form registration job.

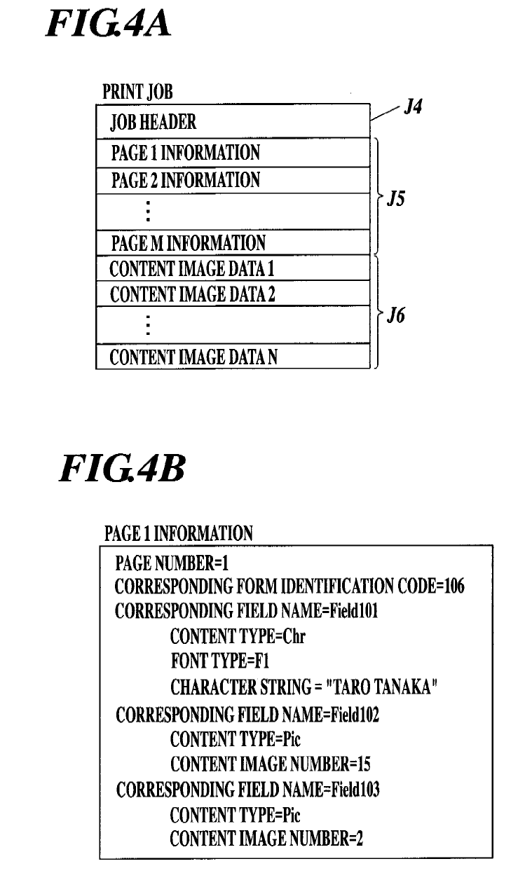

FIG. 4A shows an example of a structure of a print job. A print job includes a job header J4, page information J5 and image data J6. The job header J4 includes general information of the job, such as job name, sheet size, finishing information, etc. The page information J5 includes information from page 1 to page M. The image data J6 includes content image data 1 to N used as content. The content image data 1 to N are identified by a content image number uniquely numbered from the lead job in order of arrangement, etc.

FIG. 4B shows an example of a structure of page-1 information which is page information of the first page of the page information J5. The page-1 information includes page number (1), the corresponding form identification code (106) corresponding to a form to be processed on the page and field attribute information of each field. Here, the field attribute information includes, field identification names (Field 101 to 103) and content type (Chr, Pic, etc.). When the content type is character string (Chr), the field attribute information further includes font type (F1, F2, F3) and character string. When the content type is image (Pic), the field attribute information includes a content image number (1 to N).

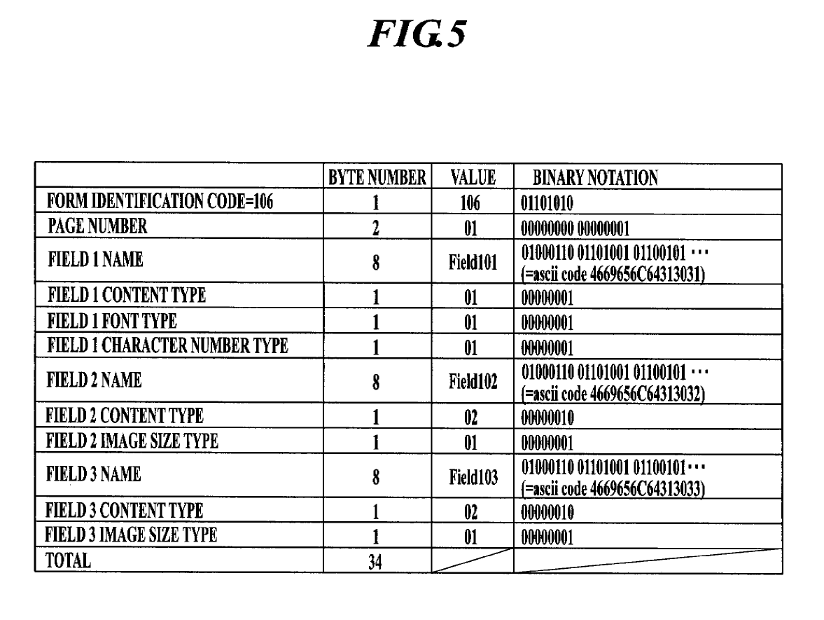

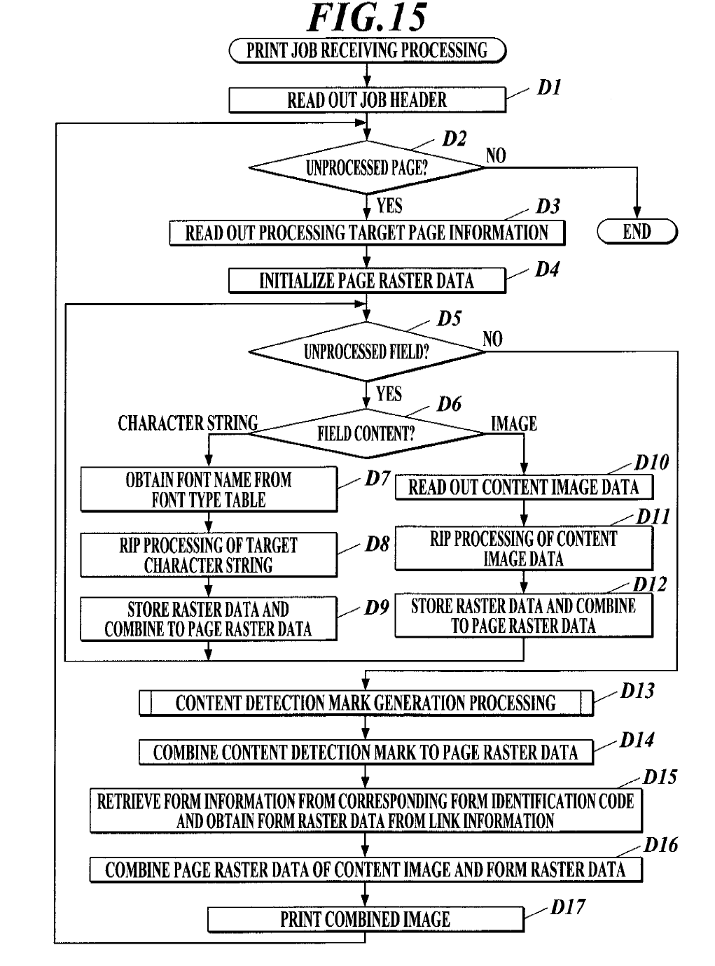

Next, the method of generation of the form detection mark will be described. As shown in FIG. 5, the attribute information of the form image is data with a structure of 34 bytes. The CPU 10 converts the values of the form identification code, page number and field attribute information (field name, content type, font type, character number type and image size type) to binary form, and arranges in one direction figures in two different densities which correspond to bit values of the binary code. The rasterized image of the arranged figures is to be the form detection mark. Specifically, when a bit value of the binary code representing the attribute information of the form image is 0, a white rectangle is arranged in one direction, and when a bit value is 1, a gray rectangle is arranged to generate a form detection mark. The form identification code and the field attribute information are obtained from the form information J2 of the form registration job. Since the page number is different in each page, the form detection mark of the page number portion is attached to the form image in the later-described print job receiving processing (see FIG. 15).

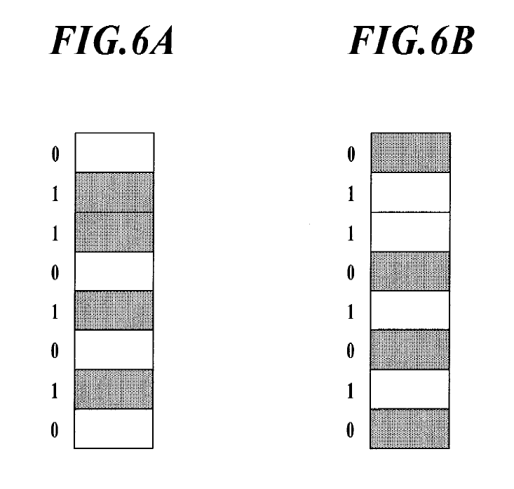

For example, when the form identification code is 106, it is 106 (decimal)=01101010 (binary), thus the form detection mark corresponding to the form identification code portion is generated as 0=white and 1=gray. FIG. 6A shows the portion of the form detection mark when the form identification code is 106.

Next, the method of generation of the content detection mark will be described. The information represented by the content detection mark is similar to the attribute information of the form image and is data with a structure of 34 bytes. The CPU 10 converts the values of the form identification code, page number and field attribute information (field name, content type, font type, character number type and image size type) to binary form, and when a bit value of the binary code is 0, a gray rectangle is arranged in one direction and when a bit value is 1, a white rectangle is arranged. The rasterized image of the arranged rectangles is to be the content detection mark. In other words, in the content detection mark, the figures are arranged in the same direction as the figures in the form detection mark, however the correspondence of the density is opposite. The form identification code, page number and field attribute information are obtained from the page information J5 and image data J6.

For example, when the form identification code is 106, it is 106 (decimal)=01101010 (binary), thus the content detection mark corresponding to the form identification code portion is generated as 0=gray and 1=white. FIG. 6B shows the portion of the content detection mark when the form identification code is 106.

When the form detection mark and the content detection mark are combined, the respective densities are added and combined. When the form detection mark is white and the content detection mark is gray, or when the form detection mark is gray and the content detection mark is white, in other words, when the information represented by the images of the form detection mark and the content detection mark match, the combined result is gray. When the form detection mark is white and the content detection mark is white, the combined result is white and when the form detection mark is gray and the content detection mark is gray, the combined result is black. In other words, when the information represented by the images of the form detection mark and the content detection mark do not match, the combined result is white or black.

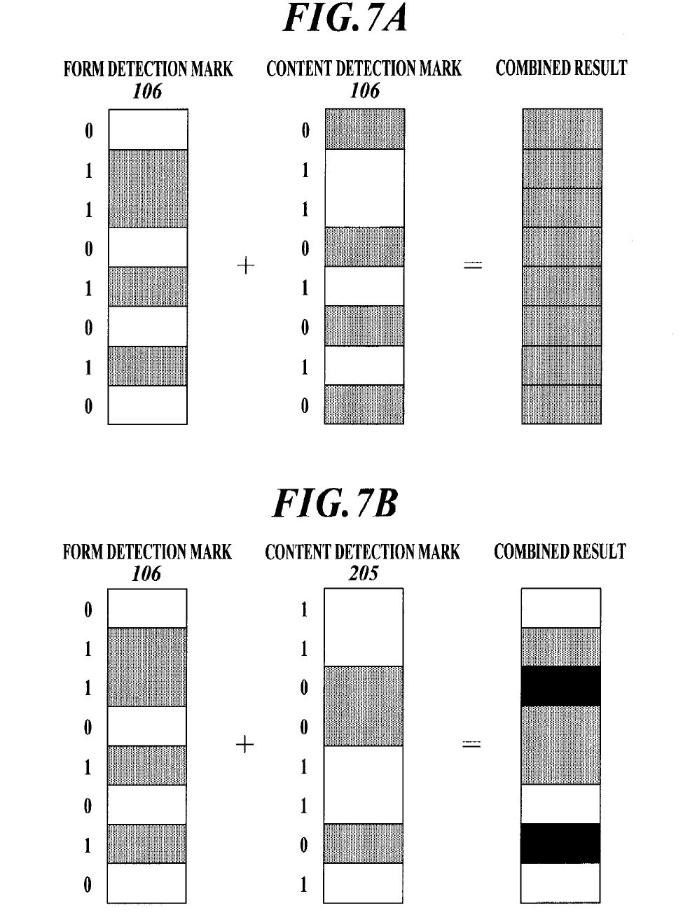

FIG. 7A shows an example of a combined result when a form detection mark (form identification code=106) and a content detection mark (form identification code=106) with the same form identification code are combined. In this case, the combined image forms a pattern in a solid gray with a uniform density. FIG. 7B shows an example of a combined result when a form detection mark (form identification code=106) and a content detection mark (form identification code=205) with a different form identification code are combined. By performing a similar processing of information other than the form identification code, a pattern entirely in a solid gray is printed only when all data is correct, whereas when there is even one error, white or black noise appears in the result.

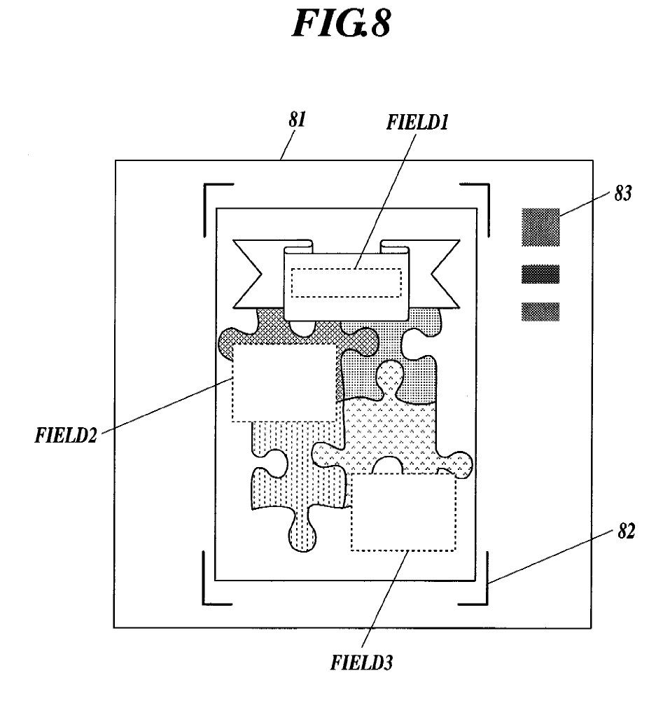

FIG. 8 shows an example of a form image. As shown in FIG. 8, there are fields 1 to 3 for variable data printing on a form image 81. Field 1 is an area where a text of a name of a client is inserted. Field 2 and Field 3 are areas where image data corresponding to the client are inserted. In the form image 81, a registration FIG. 82 is formed when necessary, and in a margin outside the figure, a form detection mark 83 is combined.

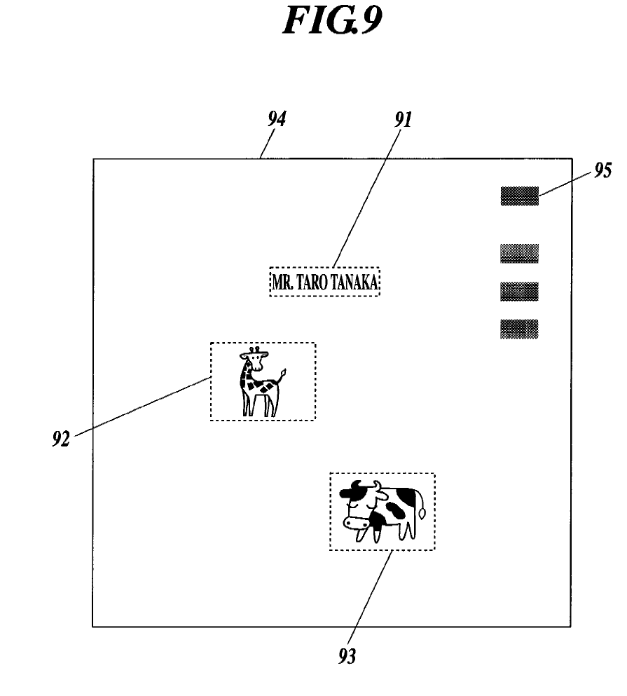

FIG. 9 shows an example of a content image. As shown in FIG. 9, raster data 91 of the client name corresponding to field 1, image data 92 corresponding to field 2 and image data 93 corresponding to field 3 are combined on a white image 94 in positions corresponding to fields 1 to 3 of the form image 81, respectively. A content detection mark 95 is combined in a position corresponding to the form detection mark 83 shown in FIG. 8.

Instead of combining raster data of the content on the white image 94, the content image may be a set including raster data of fields 1 to 3 and a content detection mark. In this case, the processing of combining the content image on the white image 94 may be omitted and speed of the whole processing may be enhanced.

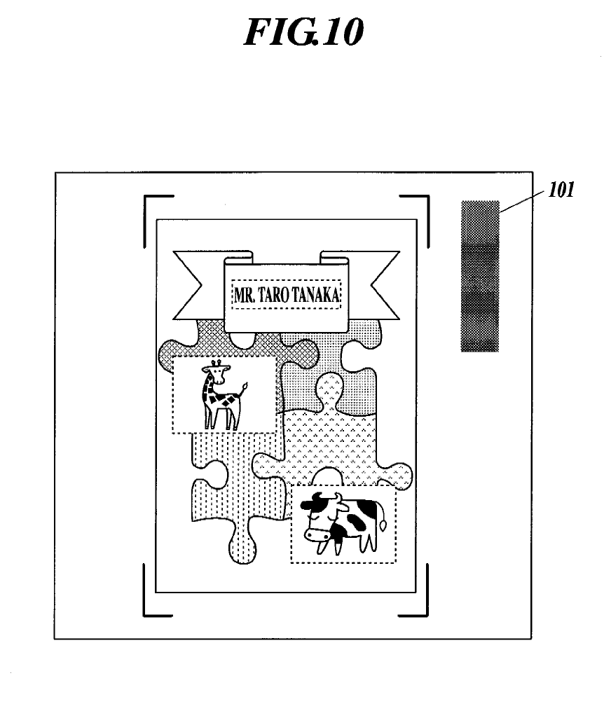

FIG. 10 shows an example of an image printed when a correct combination of a form image and a content image are combined. In the portion 101 where the form detection mark and the content detection mark are combined, a pattern in a solid gray with a uniform density is formed.

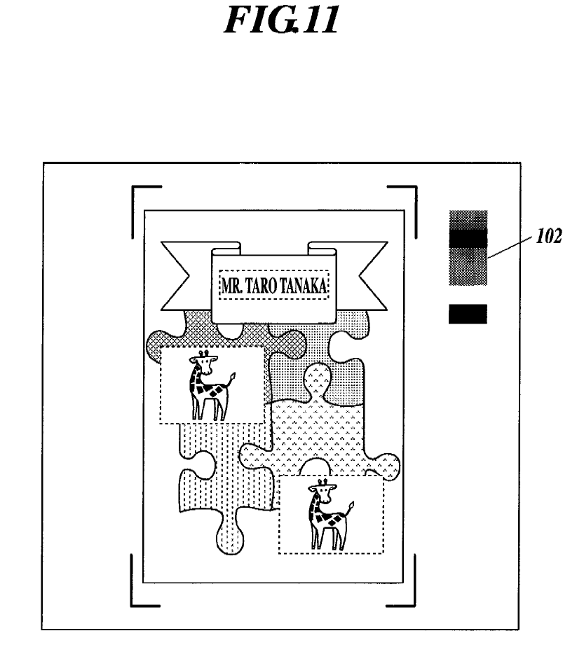

FIG. 11 shows an example of an image printed when an incorrect combination of a form image and a content image are combined. In the portion 102 where the form detection mark and the content detection mark are combined, white or black portions are formed.

Next, the operation will be described.

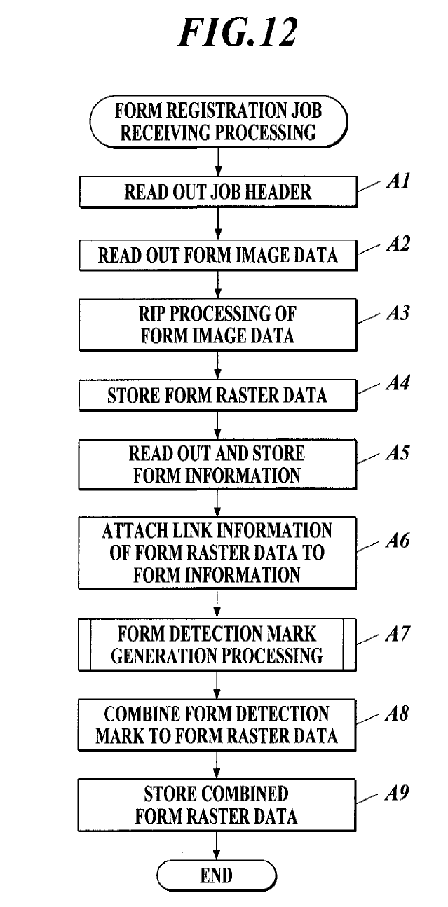

FIG. 12 is a flowchart showing a form registration job receiving processing performed in an image forming apparatus 100. The form registration job receiving processing is realized by software processing performed by the CPU 10 in conjunction with the programs (main control program 31, RIP processing program 32, form control program 33 and combining processing program 35) stored in the ROM 30.

When the communication section 50 of the image forming apparatus 100 receives a form registration job through the network, the CPU 10 reads out the job header J1 from the form registration job (step A1).

Next, the CPU 10 reads out the form image data J3 from the form registration job (step A2) and the RIP processing of the form image data J3 according to the sheet size included in the job header J1 is performed to generate raster data (hereinafter referred to as form raster data) of the form image data J3 (step A3). Here, if there is a specification of the registration mark and the like, this image is also generated. The CPU 10 stores the form raster data in the raster data storage section 21 (step A4).

Then, the CPU 10 reads out the form information J2 from the form registration job and stores the information in the information code storage section 22 (step A5). The CPU 10 attaches link information to the form information J2 in the information code storage section 22 so that the corresponding form raster data may be retrieved (step A6).

Next, the CPU 10 generates the form detection mark according to the form information J2 (step A7).

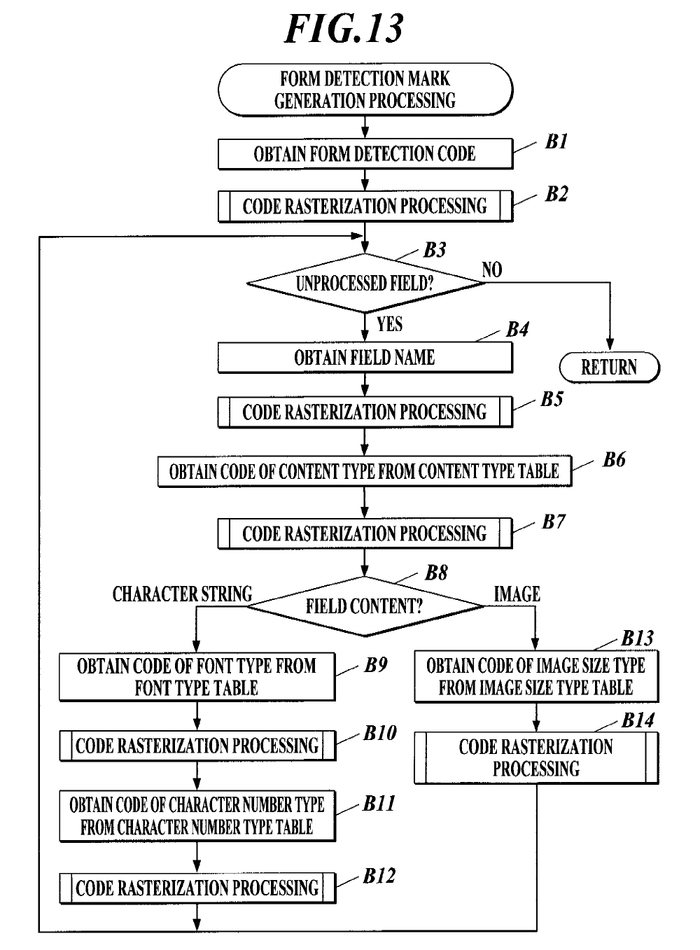

Here, the form detection mark generation processing will be described with reference to FIG. 13. The form detection mark generation processing is realized by software processing performed by the CPU 10 in conjunction with the form control program 33 stored in the ROM 30.

As shown in FIG. 13, the CPU 10 obtains the form identification code from the form information J2 stored in the information code storage section 22 (step B1) and performs the code rasterization processing of the form identification code (step B2).

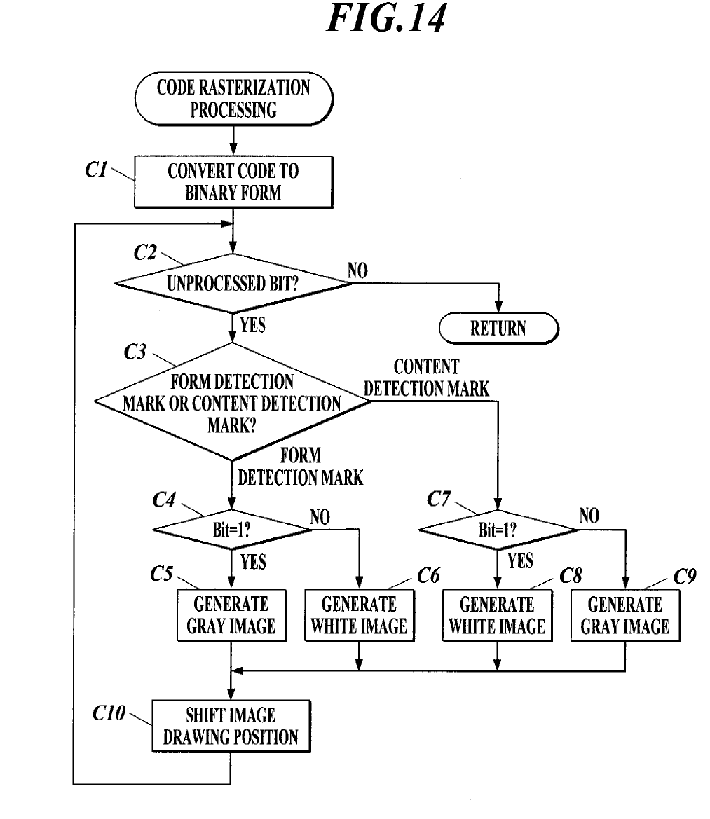

As shown in FIG. 14, in the code rasterization processing, first, the CPU 10 converts the target code to binary form (step C1).

Next, the CPU 10 determines whether or not there is an unprocessed bit in the code converted to binary form (step C2). When there is an unprocessed bit (step C2; YES), it is determined whether the detection mark under processing is a form detection mark or a content detection mark (step C3).

When the detection mark under processing is a form detection mark (step C3; form detection mark), the CPU 10 determines whether or not the target bit value is 1 (step C4). When the target bit value is 1 (step C4; YES), the CPU 10 generates raster data in which the area in the image drawing position corresponding to the target bit value is to be a gray image (step C5). When the target bit value is 0 (step C4; NO), the CPU 10 generates raster data in which the area in the image drawing position corresponding to the target bit value is to be a white image (step C6).

When the code under processing is a content detection mark (step C3; content detection mark), the CPU 10 determines whether or not the target bit value is 1 (step C7). When the target bit value is 1 (step C7; YES), the CPU 10 generates raster data in which the area in the image drawing position corresponding to the target bit value is to be a white image (step C8). When the target bit value is 0 (step C7; NO), the CPU 10 generates raster data in which the area in the image drawing position corresponding to the target bit value is to be a gray image (step C9).

After step C5, step C6, step C8, or step C9, the image drawing position is shifted (step C10), and the process returns to step C2 to repeat the processing. In step C2, when there are no more unprocessed bits (step C2; NO), the code rasterization processing ends.

As shown in FIG. 13, the CPU 10 refers to the form information J2 stored in the information code storage section 22 and determines whether or not there is an unprocessed field (step B3). When there is an unprocessed field (step B3; YES), the CPU 10 obtains a field name of the unprocessed field from the form information J2 (step B4) and performs code rasterization processing (see FIG. 14) of the ASCII code with the field name (step B5).

Next, the CPU 10 obtains the content type of the unprocessed field from the form information J2, and obtains the code corresponding to the content type from the content type table 41 (step B6). Then, code rasterization processing of the content type (see FIG. 14) is performed (step B7).

Next, the CPU 10 determines whether the content type of the field is a character string or image (step B8). When the content type is character string (step B8; character string), the CPU 10 obtains the font type of the unprocessed field from the form information J2 and obtains the code corresponding to the font type from the font type table 42 (step B9). Then, code rasterization processing (see FIG. 14) of the font type is performed (step B10).

Next, the CPU 10 obtains the character number type of the unprocessed field from the form information J2 and obtains the code corresponding to the character number type from the character number type table 43 (step B11). Then, code rasterization processing (see FIG. 14) of the character number type is performed (step B12).

In step B8, when the content type is image (step B8; image), the CPU 10 obtains the image size type of the unprocessed field from the form information J2 and obtains the code corresponding to the image size type from the image size type table 44 (step B13). Then, code rasterization processing (see FIG. 14) of the image size type is performed (step B14).

After step B12 or B14, the process returns to step B3, and the processing is repeated until there are no more unprocessed fields. In step B3, when there are no more unprocessed fields (step B3; NO), the form detection mark generation processing ends.

As shown in FIG. 12, after the form detection mark generation processing ends, the form detection mark is placed in a margin of the form raster data and combined by the CPU 10 (step A8). Then, the combined form raster data is stored in the raster data storage section 21 (step A9).

With this, the form registration job receiving processing ends.

Next, the print job receiving processing will be described. FIG. 15 is a flowchart showing a print job receiving processing performed in the image forming apparatus 100. The print job receiving processing is realized by software processing performed by the CPU 10 in conjunction with programs (main control program 31, RIP processing program 32, content control program 34, combining processing program 35) stored in the ROM 30.

When the communication section 50 of the image forming apparatus 100 receives a print job through the network, the CPU 10 reads out the job header J4 from the print job (step D1).

Next, the CPU 10 determines whether or not there is an unprocessed page in the print job (step D2). When there is an unprocessed page in the print job (step D2; YES), the CPU 10 reads out the page information of the processing target page from the print job (step D3), and stores the information in the information code storage section 22.

Next, the CPU 10 initializes (starts over) the page raster data of the target page (step D4) and the data is stored in the raster data storage section 21.

Next, the CPU 10 refers to the page information of the processing target page stored in the information code storage section 22 and determines whether or not there is an unprocessed field (step D5). When there is an unprocessed field (step D5; YES), the CPU 10 refers to the page information and determines whether the content type of the field is character string or image (step D6).

When the content type of the field is character string (step D6; character string), the CPU 10 obtains the font type from the page information and obtains the font name corresponding to the font type of the field from the font type table 42 (step D7). Then, the CPU 10 obtains the character string from the page information and performs RIP processing of the target character string represented by the font of the font name obtained in step D7 (step D8). Then, the CPU 10 stores the raster data of the target character string in the raster data storage section 21 and combines the data to the page raster data (step D9).

In step D6, when the content type of the field is image (step D6; image), the content image data corresponding to the content image number specified in the page information is read out from the print job (step D10), and RIP processing of the content image data is performed (step D11). The CPU 10 stores the raster data of the content image data in the raster data storage section 21 and combines the data to the page raster data (step D12).

After step D9 or step D12, the process returns to step D5 and the processing is repeated until there are no more unprocessed fields. When there are no more unprocessed fields (step D5; NO), the content detection mark is generated (step D13).

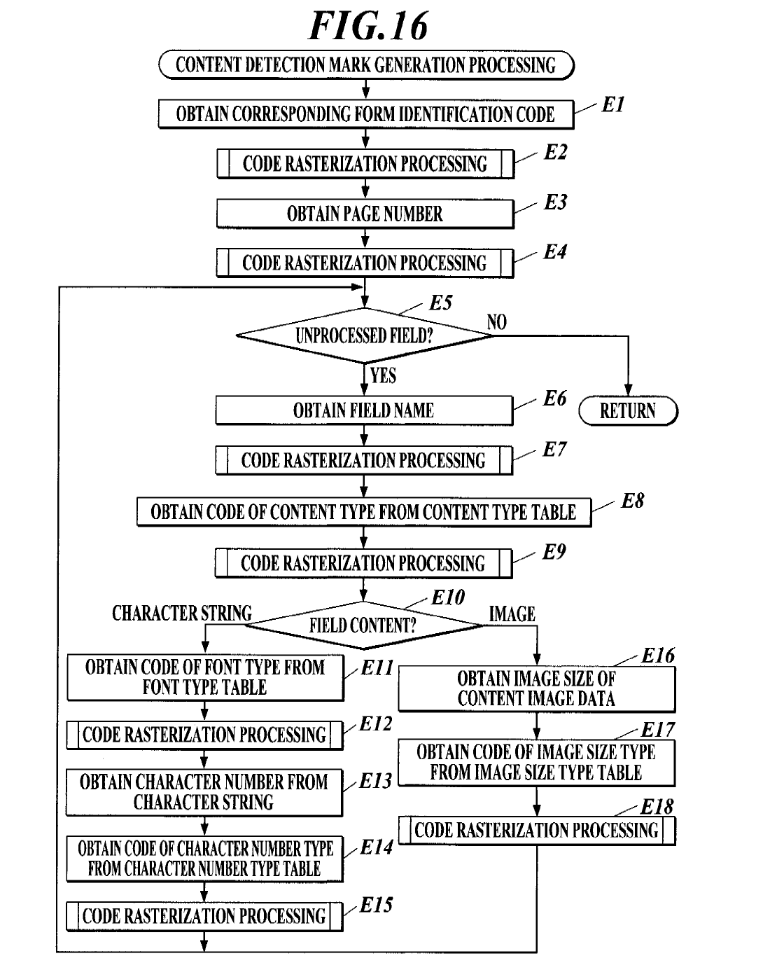

Here, the content detection mark generation processing is described with reference to FIG. 16. The content detection mark generation processing is realized by software processing performed by the CPU 10 in conjunction with the content control program 34 stored in ROM 30.

As shown in FIG. 16, the CPU 10 obtains the corresponding form identification code from the page information stored in the information code storage section 22 (step E1), and performs the code rasterization processing (see FIG. 14) of the corresponding form identification code (step E2).

Next, the CPU 10 obtains the page number from the page information (step E3) and performs the code rasterization processing (see FIG. 14) of the page number (step E4).

Next, the CPU 10 refers to the page information and determines whether or not there is an unprocessed field (step E5). When there is an unprocessed field (step E5; YES), the field name of the unprocessed field is obtained from the page information (step E6) and the code rasterization processing (see FIG. 14) of the ASCII code of the field name is performed (step E7).

Next, the CPU 10 obtains the content type of the unprocessed field from the page information and obtains the code corresponding to the content type from the content type table 41 (step E8). Then the code rasterization processing (see FIG. 14) of the content type is performed (step E9).

Next, the CPU 10 determines whether the content type of the field is character string or image (step E10). When the content type of the field is character string (step E10; character string), the font type of the unprocessed field is obtained from the page information and the code corresponding to the font type is obtained from the font type table 42 (step E11). Then, the code rasterization processing (see FIG. 14) of the font type is performed (step E12).

Next, the CPU 10 obtains the character string of the unprocessed field from the page information and obtains the character number of the character string (step E13). Then, the CPU 10 obtains the code corresponding to the character number of the character string from the character number type table 43 (step E14), and the code rasterization processing (see FIG. 14) of the character number type is performed (step E15).

In step E10, when the content type of the field is image (step E10; image), the content image number of the unprocessed field is obtained from the page information and the image size of the content image data corresponding to the content image number is obtained from the print job (step E16). Then, the code corresponding to the image size is obtained from the image size type table 44 (step E17), and the code rasterization processing (see FIG. 14) of the image size type is performed (step E18).

After step E15 or E18, the process returns to step E5, and the processing is repeated until there are no more unprocessed fields. In step E5, when there are no more unprocessed fields (step E5; NO), the content detection mark generation processing ends.

As shown in FIG. 15, after the content detection mark generation processing ends, the content detection mark is placed in a margin of the page raster data and combined by the CPU 10 (step D14). The position of the content detection mark corresponds to the position of the form detection mark in the form raster data.

Next, the CPU 10 retrieves the form information J2 of the form identified by the corresponding form identification code in the page information from the information code storage section 22 and obtains the form raster data based on the link information attached to the form information J2 from the raster data storage section 21 (step D15). Here, the form detection mark of the page number portion of the processing target page is generated and attached to the form raster data by the CPU 10.

Next, the CPU 10 combines the page raster data of the content image and the form raster data (step D16) and stores the combined raster data in the raster data storage section 21.

Next, the print section 60 prints the combined image on a sheet according to the combined raster data (step D17). Then, the process returns to step D2, and the processing is repeated until there are no more unprocessed pages. In step D2, when there are no more unprocessed pages (step D2; NO), the print job receiving processing ends.

As described above, according to the image forming apparatus 100 of the first embodiment, whether or not the combination of the form image and the content image is correct may be easily inspected visually with the pattern formed by the form detection mark and the content detection mark when the form image and the content image are combined.

Whether or not the combination of the form image and the content image is correct may also be inspected based on the form identification code, page number or the field attribute information.

Since the correspondence of the density of the figure of the content detection mark is opposite to that of the figure of the form detection mark, when the combination of the form image and the content image is correct, a pattern with a uniform density is formed. Consequently, when the combination of the form image and the content image is not correct, visual judgment may be easily performed.

In the first embodiment, since the content detection mark and the form detection mark are generated in gray and white corresponding to the bit values of the binary code, when the combination of the form image and the content image is correct, a pattern in a solid gray is formed, and when the combination of the form image and the content image is not correct, white or black portions appear. Consequently, visual judgment may be easily performed.

The content detection mark and the form detection mark include the code showing the font type and the character number type. Consequently, a mistake of font type or excess characters of the variable data may be checked.

### Second Embodiment

Next, a second embodiment of an image forming apparatus according to the present invention will be described.

In the first embodiment, an apparatus in which the raster data of the form image and the raster data of the content image are combined and printed was described. In the second embodiment, the printing processing of the form image and the content image are respectively performed in separate apparatuses.

The image forming apparatus of the second embodiment forms a content image including one or a plurality of contents to be inserted in a field on a sheet previously printed with a form image including one or a plurality of fields for inserted contents to be combined and a form detection mark showing an attribute of the form image. The method of generating a form detection mark previously printed on the sheet is similar to that of the form detection mark generation processing shown in FIG. 13, the form detection mark further including a page number generated in an order of the page.

The image forming apparatus of the second embodiment has a structure similar to the image forming apparatus 100 shown in the first embodiment, thus the same reference numerals are applied to the same components and the illustration and the description of the structure are omitted. In the following, the characteristic structure and processing of the second embodiment will be described.

In conjunction with the content control program 34 stored in the ROM 30, the CPU 10 generates a content detection mark which is integrated to a form detection mark to form a predetermined pattern when a combination of the content image and the form image is correct. In the second embodiment also, the “predetermined pattern” is a pattern in a solid gray with a uniform density. The CPU 10 generates an image with the content detection mark placed in a position in a margin of the content image corresponding to the position of the form detection mark in the form image.

According to the control by the CPU 10, the print section 60 prints a content image combined with a content detection mark so as to overlap on the image with the form image and the form detection mark previously printed on the sheet. In other words, in the second embodiment, the form detection mark and the content detection mark are combined by overlapping toner, ink and the like. Here, when the information represented by the images of the form detection mark and the content detection mark match, the result of the overlapped image is gray. When the information represented by the images of the form detection mark and the content detection mark do not match, the result of the overlapped image is white or black.

Next, the operation is described.

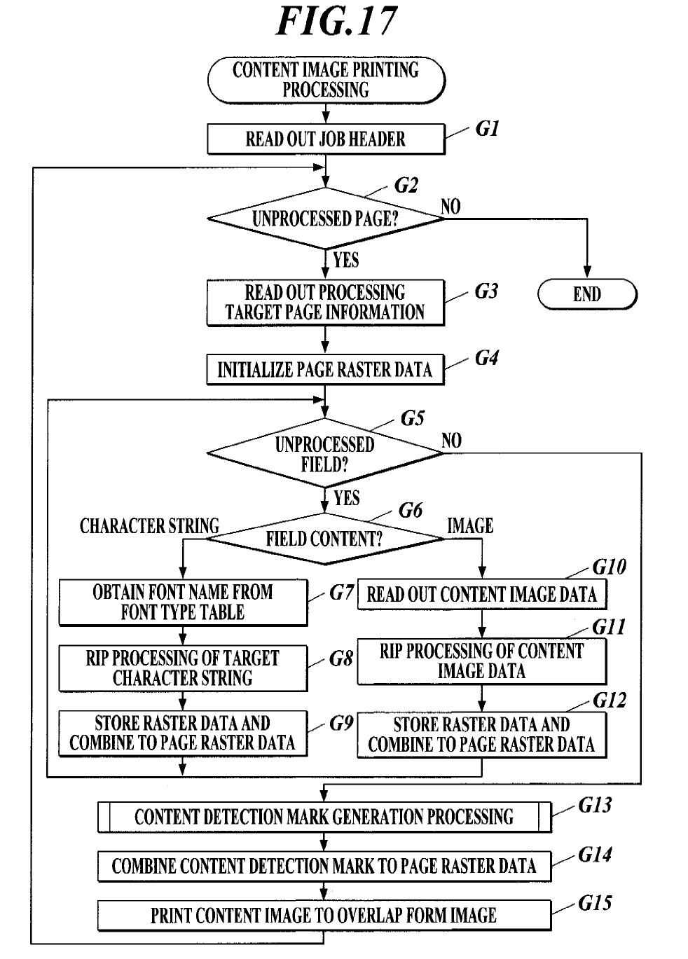

FIG. 17 is a flowchart showing a content image printing processing performed in an image forming apparatus of the second embodiment. Step G1 to step G14 of the content image printing processing is similar to step D1 to step D14 of the print job receiving processing shown in FIG. 15, thus the description is omitted.

After step G14, according to the page raster data combined with the content detection mark, the print section 60 prints the content image overlapping a sheet previously printed with the form image and the form detection mark (step G15). Then, the process returns to step G2 and the processing is repeated until there are no more unprocessed pages. In step G2, when there are no more unprocessed pages (step G2; NO), the content image printing processing ends.

As described above, according to the image forming apparatus of the second embodiment, whether or not the combination of the form image and the content image is correct may be easily inspected visually with the pattern formed by the form detection mark and the content detection mark when the content image is printed overlapping the form image.

For example, even when a form and content are respectively printed by different printers, where a form printer has a strong point in high speed printing, and a content printer prints data in a database while replacing the data to be printed, it is possible to inspect whether or not there is a mismatch in the respective input data. Consequently, printing data for client A onto a form for client B by mistake may be prevented.

The above descriptions of the above-described embodiments are examples of the image forming apparatus of the present invention, and it is not limited to these examples. The detailed structures and operations of the components comprising the image forming apparatus may be modified appropriately without departing from the spirit of the invention.

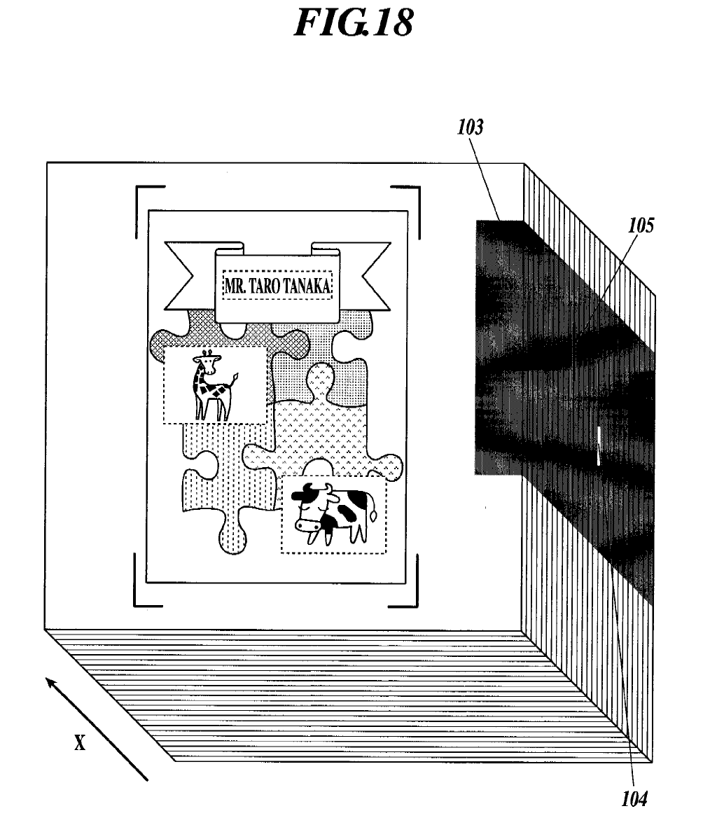

For example, in the above-described embodiments, the form detection mark and the content detection mark are printed in the margin of the sheet and the user inspects the match by visual examination while turning each page of the printed material. However, as shown in FIG. 18, a mark 103 combining the form detection mark and the content detection mark may be printed on an edge of a sheet. In this case, a combined result of the form detection mark and the content detection mark appears on a side of the printed material piled in an X direction. Consequently, the user may check at a glance whether or not there is a white portion 104 or black portion 105 considered to be noise being not gray without turning each page of the printed material.

In the above-described embodiments, examples in which the form detection mark and the content detection mark comprise white or gray figures arranged in one direction were described, however, other figures may be used, such as generating the form detection mark and content detection mark by arranging the data in two directions, (in a grid-like pattern) and the like.

In the above-described embodiments, as for the form detection mark, when the bit value of the binary data is 0, the mark is generated as white, and when the bit value is 1, the mark is generated as gray, whereas as for the content detection mark, when the bit value is 0, the mark is generated as gray, and when the bit value is 1, the mark is generated as white. However, by obtaining one's complement of the binary data, when this bit value is 0, the content detection mark may be generated as white and when this bit value is 1, the mark may be generated as gray. The relation between white and gray may be opposite.

In the above-described embodiments, as for the figures comprising the form detection mark and the content detection mark, the figures with two different densities are gray and white, however, colors which do not result in black when overlapped such as pale red, pale blue, etc. and white may be used.

According to an aspect of the preferred embodiments, there is provided an image forming method for forming a combined image by combining a first image and a second image to be combined, the first image including an inserting area in which an inserting image is to be inserted and the second image including the inserting image to be inserted in the inserting area, the method comprising:

placing a first detection mark showing an attribute of the first image in a margin of the first image; and

placing a second detection mark in a margin of the second image in a position corresponding to a position of the first detection mark in the first image so that when a combination of the first image and the second image is correct, the second detection mark is integrated to the first detection mark to form a predetermined pattern.

According to this image forming method, whether or not a combination of the first image and the second image is correct may be easily inspected visually by the pattern formed with the first detection mark and the second detection mark.

Preferably, in the image forming method, the attribute of the first image includes at least one of identification information, a page number and an inserting area attribute of the first image.

According to this image forming method, based on at least one of identification information, a page number and an inserting area attribute of the first image, whether or not the combination of the first image and the second image is correct may be inspected.

Preferably, in the image forming method, the first detection mark is formed with figures arranged in one direction, the figures having two different densities corresponding respectively to bit values of a binary code which represents the attribute of the first image; and

the second detection mark is formed with the figures arranged in the same direction as the first detection mark and the densities of the figures are opposite of those of the first detection mark.

According to this image forming method, densities of the figures of the second detection mark are opposite of those of the first detection mark and when a combination of the first image and the second image is correct, a pattern with a uniform density is formed, thus it is easy to determine visually when the combination of the first image and the second image is not correct.

Preferably, in the image forming method, the two different densities of the figures which form the first detection mark and the second detection mark are gray and white.

According to this image forming method, when a combination of the first image and the second image is correct, a pattern with a solid gray is formed, and when the combination of the first image and the second image is not correct, white or black portions appear, thus it is easy to determine visually.

According to another aspect of the preferred embodiments, there is provided an image forming apparatus for forming a combined image by combining a first image and a second image to be combined, the first image including an inserting area in which an inserting image is to be inserted and the second image including the inserting image to be inserted in the inserting area, the apparatus comprising:

a control section to place a first detection mark showing an attribute of the first image in a margin of the first image and a second detection mark in a margin of the second image in a position corresponding to a position of the first detection mark in the first image so that when a combination of the first image and the second image is correct, the second detection mark is integrated to the first detection mark to form a predetermined pattern, and the control section combines the first image and the second image; and

a print section to print onto a sheet the combined image combined by the control section.

According to this image forming apparatus, whether or not a combination of the first image and the second image is correct may be easily inspected visually by the pattern formed with the first detection mark and the second detection mark.

Preferably, in the image forming apparatus, the attribute of the first image includes at least one of identification information, a page number and an inserting area attribute of the first image.

According to this image forming apparatus, based on at least one of identification information, a page number and an inserting area attribute of the first image, whether or not the combination of the first image and the second image is correct may be inspected.

Preferably, in the image forming apparatus, the first detection mark is formed with figures arranged in one direction, the figures having two different densities corresponding respectively to bit values of a binary code which represents the attribute of the first image; and

the second detection mark is formed with the figures arranged in the same direction as the first detection mark and the densities of the figures are opposite of those of the first detection mark.

According to this image forming apparatus, densities of the figures of the second detection mark are opposite of those of the first detection mark and when a combination of the first image and the second image is correct, a pattern with a uniform density is formed, thus it is easy to determine visually when the combination of the first image and the second image is not correct.

Preferably, in the image forming apparatus, the two different densities of the figures which form the first detection mark and the second detection mark are gray and white.

According to this image forming apparatus, when a combination of the first image and the second image is correct, a pattern with a solid gray is formed, and when the combination of the first image and the second image is not correct, white or black portions appear, thus it is easy to determine visually.

According to another aspect of the preferred embodiments, there is provided an image forming apparatus which forms a second image, including an inserting image to be inserted in an inserting area, onto a sheet previously printed with a first image including the inserting area in which the inserting image is to be inserted and a first detection mark representing an attribute of the first image, the apparatus comprising:

a control section to generate an image including a second image and a second detection mark placed in a margin of the second image in a position corresponding to a position of the first detection mark in the first image so that when a combination of the first image and the second image is correct, the second detection mark is integrated to the first detection mark to form a predetermined pattern; and

a print section to print onto the sheet the image generated by the control section.

According to this image forming apparatus, whether or not a combination of the first image and the second image is correct may be easily inspected visually by the pattern formed with the first detection mark and the second detection mark.

Preferably, in the image forming apparatus, the attribute of the first image includes at least one of identification information, a page number and an inserting area attribute of the first image.

According to this image forming apparatus, based on at least one of identification information, a page number and an inserting area attribute of the first image, whether or not the combination of the first image and the second image is correct may be inspected.

Preferably, in the image forming apparatus, the first detection mark is formed with figures arranged in one direction, the figures having two different densities corresponding respectively to bit values of a binary code which represents the attribute of the first image; and

the second detection mark is formed with the figures arranged in the same direction as the first detection mark and the densities of the figures are opposite of those of the first detection mark.

According to this image forming apparatus, densities of the figures of the second detection mark are opposite of those of the first detection mark and when a combination of the first image and the second image is correct, a pattern with a uniform density is formed, thus it is easy to determine visually when the combination of the first image and the second image is not correct.

Preferably, in the image forming apparatus, the two different densities of the figures which form the first detection mark and the second detection mark are gray and white.

According to this image forming apparatus, when a combination of the first image and the second image is correct, a pattern with a solid gray is formed, and when the combination of the first image and the second image is not correct, white or black portions appear, thus it is easy to determine visually.

According to another aspect of the preferred embodiments, there is provided a computer-readable medium embodying a program to allow a computer for forming a combined image by combining a first image and a second image to be combined, the first image including an inserting area in which an inserting image is to be inserted and the second image including the inserting image to be inserted in the inserting area, to perform the functions of:

placing a first detection mark showing an attribute of the first image in a margin of the first image; and

placing a second detection mark in a margin of the second image in a position corresponding to a position of the first detection mark in the first image so that when a combination of the first image and the second image is correct, the second detection mark is integrated to the first detection mark to form a predetermined pattern.

According to this computer-readable medium, whether or not a combination of the first image and the second image is correct may be easily inspected visually by the pattern formed with the first detection mark and the second detection mark.

Preferably, in the computer-readable medium, the attribute of the first image includes at least one of identification information, a page number and an inserting area attribute of the first image.

According to this computer-readable medium, based on at least one of identification information, a page number and an inserting area attribute of the first image, whether or not the combination of the first image and the second image is correct may be inspected.

Preferably, in the computer-readable medium, the first detection mark is formed with figures arranged in one direction, the figures having two different densities corresponding respectively to bit values of a binary code which represents the attribute of the first image; and

the second detection mark is formed with the figures arranged in the same direction as the first detection mark and the densities of the figures are opposite of those of the first detection mark.

According to this computer-readable medium, densities of the figures of the second detection mark are opposite of those of the first detection mark and when a combination of the first image and the second image is correct, a pattern with a uniform density is formed, thus it is easy to determine visually when the combination of the first image and the second image is not correct.

Preferably, in the computer-readable medium, the two different densities of the figures which form the first detection mark and the second detection mark are gray and white.

According to this computer-readable medium, when a combination of the first image and the second image is correct, a pattern with a solid gray is formed, and when the combination of the first image and the second image is not correct, white or black portions appear, thus it is easy to determine visually.

Although various exemplary embodiments have been shown and described, the invention is not limited to the embodiments shown. Therefore, the scope of the invention is intended to be limited solely by the scope of the claims that follow.

What is claimed is:

1. An image forming method for forming a combined image by combining a first image and a second image to be combined, the first image including an inserting area in which an inserting image is to be inserted and the second image including the inserting image to be inserted in the inserting area, the method comprising:
placing a first detection mark showing an attribute of the first image in a margin of the first image; and
placing a second detection mark in a margin of the second image in a position corresponding to a position of the first detection mark in the first image so that when a combination of the first image and the second image is correct, the second detection mark is integrated to the first detection mark to form a predetermined pattern.

2. The image forming method of claim 1, wherein the attribute of the first image includes at least one of identification information, a page number and an inserting area attribute of the first image.

3. The image forming method of claim 1, wherein the first detection mark is formed with figures arranged in one direction, the figures having two different densities corresponding respectively to bit values of a binary code which represents the attribute of the first image; and
the second detection mark is formed with the figures arranged in the same direction as the first detection mark and the densities of the figures are opposite of those of the first detection mark.

4. The image forming method of claim 3, wherein the two different densities of the figures which form the first detection mark and the second detection mark are gray and white.

5. An image forming apparatus for forming a combined image by combining a first image and a second image to be combined, the first image including an inserting area in which an inserting image is to be inserted and the second image including the inserting image to be inserted in the inserting area, the apparatus comprising:
a control section to place a first detection mark showing an attribute of the first image in a margin of the first image and a second detection mark in a margin of the second image in a position corresponding to a position of the first detection mark in the first image so that when a combination of the first image and the second image is correct, the second detection mark is integrated to the first detection mark to form a predetermined pattern, and the control section combines the first image and the second image; and
a print section to print onto a sheet the combined image combined by the control section.

6. The image forming apparatus of claim 5, wherein the attribute of the first image includes at least one of identification information, a page number and an inserting area attribute of the first image.

7. The image forming apparatus of claim 5, wherein the first detection mark is formed with figures arranged in one direction, the figures having two different densities corresponding respectively to bit values of a binary code which represents the attribute of the first image; and
the second detection mark is formed with the figures arranged in the same direction as the first detection mark and the densities of the figures are opposite of those of the first detection mark.

8. The image forming apparatus of claim 7, wherein the two different densities of the figures which form the first detection mark and the second detection mark are gray and white.

9. An image forming apparatus which forms a second image, including an inserting image to be inserted in an inserting area, onto a sheet previously printed with a first image including the inserting area in which the inserting image is to be inserted and a first detection mark representing an attribute of the first image, the apparatus comprising:
a control section to generate an image including a second image and a second detection mark placed in a margin of the second image in a position corresponding to a position of the first detection mark in the first image so that when a combination of the first image and the second image is correct, the second detection mark is integrated to the first detection mark to form a predetermined pattern; and
a print section to print onto the sheet the image generated by the control section.

10. The image forming apparatus of claim 9, wherein the attribute of the first image includes at least one of identification information, a page number and an inserting area attribute of the first image.

11. The image forming apparatus of claim 9, wherein the first detection mark is formed with figures arranged in one direction, the figures having two different densities corresponding respectively to bit values of a binary code which represents the attribute of the first image; and
the second detection mark is formed with the figures arranged in the same direction as the first detection mark and the densities of the figures are opposite of those of the first detection mark.

12. The image forming apparatus of claim 11, wherein the two different densities of the figures which form the first detection mark and the second detection mark are gray and white.

13. A computer-readable medium embodying a program to allow a computer for forming a combined image by combining a first image and a second image to be combined, the first image including an inserting area in which an inserting image is to be inserted and the second image including the inserting image to be inserted in the inserting area, to perform the functions of:
placing a first detection mark showing an attribute of the first image in a margin of the first image; and
placing a second detection mark in a margin of the second image in a position corresponding to a position of the first detection mark in the first image so that when a combination of the first image and the second image is correct, the second detection mark is integrated to the first detection mark to form a predetermined pattern.

14. The computer-readable medium of claim 13, wherein the attribute of the first image includes at least one of identification information, a page number and an inserting area attribute of the first image.

15. The computer-readable medium of claim 13, wherein the first detection mark is formed with figures arranged in one direction, the figures having two different densities corresponding respectively to bit values of a binary code which represents the attribute of the first image; and
the second detection mark is formed with the figures arranged in the same direction as the first detection mark and the densities of the figures are opposite of those of the first detection mark.

16. The computer-readable medium of claim 15, wherein the two different densities of the figures which form the first detection mark and the second detection mark are gray and white.
